(19) United States
(12) Patent Application Publication
(10) Pub. No.: US 2022/0117306 A1
(43) Pub. Date: Apr. 21, 2022

(54) DUAL-HEATING TOBACCO HEATER AND HEATING METHOD, AND HEATED TOBACCO PRODUCT

(71) Applicant: ITM SEMICONDUCTOR CO., LTD., Cheongju-si (KR)

(72) Inventors: Hyuk Hwi NA, Cheongju-si (KR); Ho Seok HWANG, Gunpo-si (KR); Sang Seob LIM, Cheonan-si (KR); Chi Sun SONG, Cheongju-si (KR); Seong Beom PARK, Cheongju-si (KR)

(21) Appl. No.: 17/390,214

(22) Filed: Jul. 30, 2021

(30) Foreign Application Priority Data
Oct. 21, 2020 (KR) 10-2020-0136723

(51) Int. Cl. A24F 40/465; H05B 3/42; A24F 40/20; A24F 40/57; A24F 40/53

(52) U.S. Cl. CPC A24F 40/465; H05B 3/42; A24F 40/53; A24F 40/57; A24F 40/20

(57) ABSTRACT

Provided are a dual-heating tobacco heater and heating method capable of achieving optimal heating efficiency by initially rapidly heating a tobacco container such as a tobacco stick through direct heating and then maintaining the temperature and reducing power consumption through induction heating, and a heated tobacco product. The dual-heating tobacco heater may include a heating element having a shape corresponding to at least a part of a tobacco container to heat the tobacco container, a first heater being in thermal contact with the heating element to heat the heating element through resistive heating, a second heater spaced apart from the heating element by a certain distance to heat the heating element through induction heating, and an insulating member provided between the first and second heaters.

### CROSS-REFERENCE TO RELATED PATENT APPLICATION

This application claims the benefit of Korean Patent Application No. 10-2020-0136723, filed on Oct. 21, 2020, in the Korean Intellectual Property Office, the disclosure of which is incorporated herein in its entirety by reference.

### BACKGROUND

### 1. Field

The present invention relates to a dual-heating tobacco heater and heating method, and a heated tobacco product, and more particularly, to a dual-heating tobacco heater and heating method capable of achieving optimal heating efficiency by initially rapidly heating a tobacco container such as a tobacco stick through direct heating and then maintaining the temperature and reducing power consumption through induction heating, and a heated tobacco product.

### 2. Description of the Related Art

Tobacco products using a separate holder, e.g., heated tobacco products, are structurally limited in battery capacity and thus energy efficiency may be a very critical issue.

Due to the limit in battery capacity, when a heating element is heated through direct heating using resistive heating, a sufficient preheating temperature may be rapidly achieved but long-time use may not be ensured because of large power consumption for continuous heating.

On the other hand, when the heating element is heated through induction heating having high energy efficiency, the sufficient preheating temperature may not be easily achieved or an excessively long time may be taken to reach the sufficient preheating temperature, thereby causing user inconvenience.

### SUMMARY

The present invention provides a dual-heating tobacco heater and heating method capable of maximizing optimal heating efficiency and increasing a heat maintenance period with a low battery capacity by heating a heating element to a proper temperature within a short time through direct heating and then greatly reducing power consumption of the heating element through induction heating, of achieving applicability to heated tobacco products using a separate holder, and of enabling accurate and precise temperature control by sensing a temperature based on a resistance value measured during direct heating, and a heated tobacco product. However, the scope of the present invention is not limited thereto.

According to an aspect of the present invention, there is provided a dual-heating tobacco heater including a heating element having a shape corresponding to at least a part of a tobacco container to heat the tobacco container, a first heater being in thermal contact with the heating element to heat the heating element through resistive heating, a second heater spaced apart from the heating element by a certain distance to heat the heating element through induction heating, and an insulating member provided between the first and second heaters.

The heating element may have a pipe shape to insert therein a part of the tobacco container having a cylindrical shape, and be made of metal capable of achieving high thermal conductivity and enabling induction heating.

The first heater may be a direct heater wound around an outer circumferential surface of the heating element in a coil shape, and the second heater may be an induction heater wound around an outer circumferential surface of the insulating member in a coil shape.

The insulating member may be made of at least one of polyetheretherketone (PEEK), Teflon, plastic, an air layer, and combinations thereof, which have high heat resistance.

The dual-heating tobacco heater may further include an electromagnetic shield surrounding the second heater to block electromagnetic waves generated by the second heater, and a protection member surrounding the electromagnetic shield to protect the electromagnetic shield.

The dual-heating tobacco heater may further include a controller for applying direct current (DC) or alternating current (AC) power for resistive heating to the first heater for a certain period of time or at an early stage of heating when a heating temperature is lower than a reference value, and applying high-frequency power for induction heating to the second heater after the certain period of time or after the heating temperature reaches the reference value.

The controller may include a resistive heater control circuit for applying the DC or AC power for resistive heating to the first heater, an induction heater control circuit for applying the high-frequency power for induction heating to the second heater by using a full-bridge converter, a resistance value measurer for measuring a resistance value of the first heater and outputting a resistance value signal, a temperature determiner for calculating temperature information of the first heater by using the resistance value measured by the resistance value measurer, and applying a switch control signal based on the calculated temperature information, and a switch for receiving the switch control signal from the temperature determiner to drive the resistive heater control circuit for the certain period of time or at the early stage of heating when the heating temperature is lower than the reference value, or drive the induction heater control circuit after the certain period of time or after the heating temperature reaches the reference value.

According to another aspect of the present invention, there is provided a heated tobacco product including the above-described dual-heating tobacco heater.

According to another aspect of the present invention, there is provided a dual-heating tobacco heating method including (a) applying power for resistive heating to a first heater being in thermal contact with a heating element to directly heat the heating element through resistive heating, for a certain period of time or at an early stage of heating when a heating temperature is lower than a reference value, and (b) applying high-frequency power for induction heating to a second heater spaced apart from the heating element by a certain distance to heat the heating element through induction heating, after the certain period of time or after the heating temperature reaches the reference value.

The dual-heating tobacco heating method may further include, before step (b), (c) determining whether the heating temperature reaches the reference value, by measuring a resistance value of the first heater.

### BRIEF DESCRIPTION OF THE DRAWINGS

The above and other features and advantages of the present invention will become more apparent by describing in detail embodiments thereof with reference to the attached drawings in which:

FIG. 1 is a perspective view of a second heater of a dual-heating tobacco heater, according to some embodiments of the present invention;

FIG. 2 is a perspective view of a first heater of the dual-heating tobacco heater of FIG. 1;

FIG. 3 is an exploded perspective view of the dual-heating tobacco heater of FIG. 1;

FIG. 4 is a block diagram of a controller of the dual-heating tobacco heater of FIG. 1;

FIG. 5 is a graph showing a heating temperature over time based on a frequency of power applied by an induction heater control circuit of the dual-heating tobacco heater of FIG. 1; and

FIG. 6 is a flowchart of a dual-heating tobacco heating method according to some embodiments of the present invention.

### DETAILED DESCRIPTION

Hereinafter, the present invention will be described in detail by explaining embodiments of the invention with reference to the attached drawings. The invention may, however, be embodied in many different forms and should not be construed as being limited to the embodiments set forth herein; rather, these embodiments are provided so that this disclosure will be thorough and complete, and will fully convey the concept of the invention to one of ordinary skill in the art. In the drawings, the sizes of elements may be exaggerated or reduced for convenience of explanation.

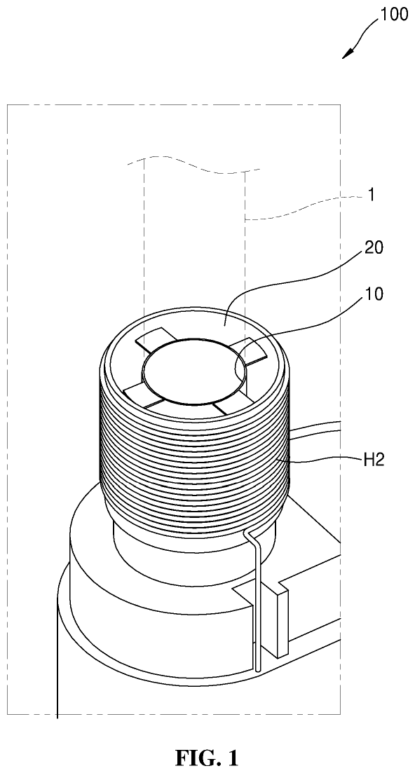

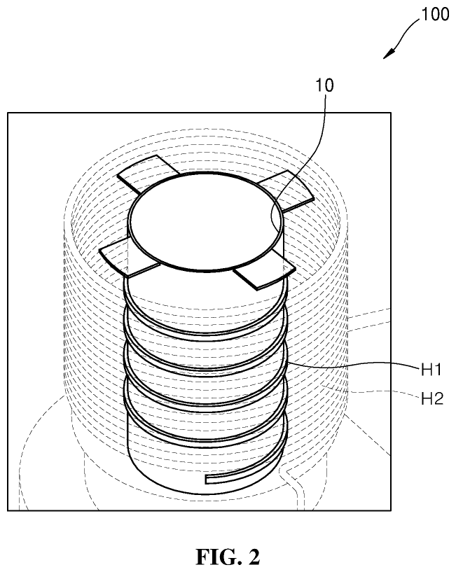

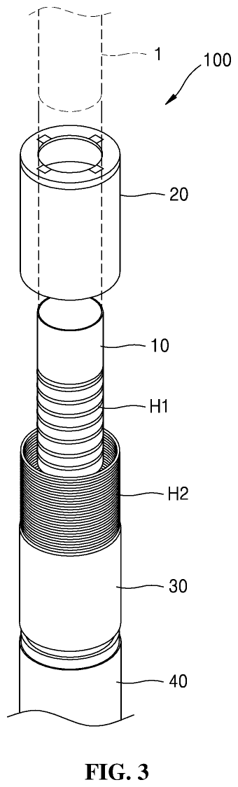

FIG. 1 is a perspective view of a second heater H2 of a dual-heating tobacco heater 100, according to some embodiments of the present invention, FIG. 2 is a perspective view of a first heater H1 of the dual-heating tobacco heater 100 of FIG. 1, and FIG. 3 is an exploded perspective view of the dual-heating tobacco heater 100 of FIG. 1.

Initially, as illustrated in FIGS. 1 to 3, the dual-heating tobacco heater 100 according to some embodiments of the present invention may heat a tobacco container such as a tobacco stick by using dual coils, and mainly include a heating element 10, the first heater H1, the second heater H2, and an insulating member 20.

For example, the heating element 10 may be a kind of direct-contact heat exchange structure having a shape corresponding to at least a part of a tobacco container 1 such as a tobacco stick to heat the tobacco container 1.

Specifically, for example, as illustrated in FIGS. 1 to 3, the heating element 10 may have a pipe shape to insert therein a part of the tobacco container 1 having an overall cylindrical shape, and be made of at least partially magnetic metal including iron to achieve high thermal conductivity and enable induction heating, e.g., stainless steel, steel, cast iron, or some aluminum alloys.

However, the heating element 10 is not limited to the illustration and, in addition to the pipe shape, heating elements of a wide variety of shapes, e.g., pin-, plate-, and circuit-shaped heating elements insertable into a part of the tobacco container 1, are all usable.

For example, as illustrated in FIGS. 1 to 3, the first heater H1 may be a heater structure having high electrical resistivity and being in thermal contact with the heating element 10 to directly heat the heating element 10 through resistive heating by receiving direct current (DC) (or alternating current (AC)) power.

Specifically, for example, the first heater H1 may be a direct heater wound around the outer circumferential surface of the heating element 10 in a coil shape, and use a conductive material having high heat resistance, high electrical resistivity, and good formability, i.e., iron-chromium alloy, nickel-chromium alloy, tungsten, platinum, molybdenum silicide, or silicon carbide.

However, the first heater H1 is not limited to the above-described shape and material, and heating elements of a wide variety of shapes and materials, e.g., direct heating lines and plates, are all usable.

Meanwhile, for example, as illustrated in FIGS. 1 to 3, the second heater H2 may be a kind of induction heating coil structure spaced apart from the heating element 10 by a certain distance to heat the heating element 10 through induction heating without being in direct contact with the heating element 10.

Specifically, for example, the second heater H2 may be an induction heater wound around the outer circumferential surface of the insulating member 20 in a coil shape, and be made of copper or aluminum having low electrical resistivity to form an inductive electromagnetic field by receiving high-frequency AC current.

Therefore, the first heater H1 having a coil diameter less than the coil diameter of the second heater H2 may be coaxially provided inside the second heater H2.

In this case, the insulating member 20 may be provided between the first and second heaters H1 and H2 to prevent interference or a short circuit therebetween.

As illustrated in FIGS. 1 to 3, the insulating member 20 may be made of an insulating material capable of insulating the first and second heaters H1 and H2 from each other, e.g., at least one of polyetheretherketone (PEEK), Teflon, plastic, an air layer, and combinations thereof, which have high insulation performance and high heat resistance to transfer, toward the heating element 10, the inductive electromagnetic field induced by the second heater H2.

Meanwhile, for example, as illustrated in FIGS. 1 to 3, the dual-heating tobacco heater 100 according to some embodiments of the present invention may further include an electromagnetic shield 30 surrounding the second heater H2 to block electromagnetic waves generated by the second heater H2, and a protection member 40 surrounding the electromagnetic shield 30 to protect the electromagnetic shield 30.

Herein, the electromagnetic shield 30 may use a material capable of blocking electromagnetic waves generated during induction heating, e.g., a ferrite, aluminum, or copper sheet.

Herein, the protection member 40 may also be made of at least one of PEEK, Teflon, plastic, an air layer, and combinations thereof, which have high insulation performance and high heat resistance.

Therefore, high-temperature heat energy generated by the first heater H1 may be prevented from leaking outside by using the protection member 40, and the inductive electromagnetic field generated by the second heater H2 may be prevented from being emitted outside by using the electromagnetic shield 30.

Accordingly, various safety accidents of a user, e.g., burns, may be prevented and bad influences on human bodies or other electronic devices may also be prevented by blocking electromagnetic waves generated during induction heating.

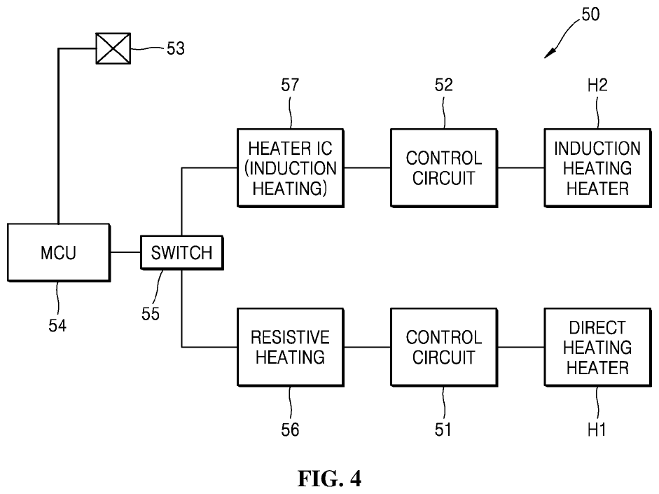

FIG. 4 is a block diagram of a controller 50 of the dual-heating tobacco heater 100 of FIG. 1.

As illustrated in FIG. 4, the dual-heating tobacco heater 100 according to some embodiments of the present invention may further include the controller 50 for applying DC or AC power for resistive heating to the first heater H1 for a certain period of time or at an early stage of heating when a heating temperature is lower than a reference value, and applying high-frequency power for induction heating to the second heater H2 after the certain period of time or after the heating temperature reaches the reference value.

As illustrated in FIGS. 1 to 4, the controller 50 may include a resistive heater control circuit 51 for applying the DC or AC power to the first heater H1 by using a resistive heating circuit 56, an induction heater control circuit 52 for applying the high-frequency power for induction heating to the second heater H2 by using an induction heater IC 57 having a full-bridge converter, a resistance value measurer 53 for measuring a resistance value of the first heater H1 and outputting a resistance value signal, a temperature determiner 54 for calculating temperature information of the first heater H1 by using the resistance value measured by the resistance value measurer 53, and applying a switch control signal based on the calculated temperature information, and a switch 55 for receiving the switch control signal from the temperature determiner 54 to drive the resistive heater control circuit 51 for the certain period of time or at the early stage of heating when the heating temperature is lower than the reference value, or drive the induction heater control circuit 52 after the certain period of time or after the heating temperature reaches the reference value.

Therefore, the controller 50 may measure the resistance value of the first heater H1 to calculate the temperature information of the first heater H1, and drive the resistive heater control circuit 51 for the certain period of time or at the early stage of heating when the heating temperature is lower than the reference value, or drive the induction heater control circuit 52 after the certain period of time or after the heating temperature reaches the reference value, based on the calculated temperature information.

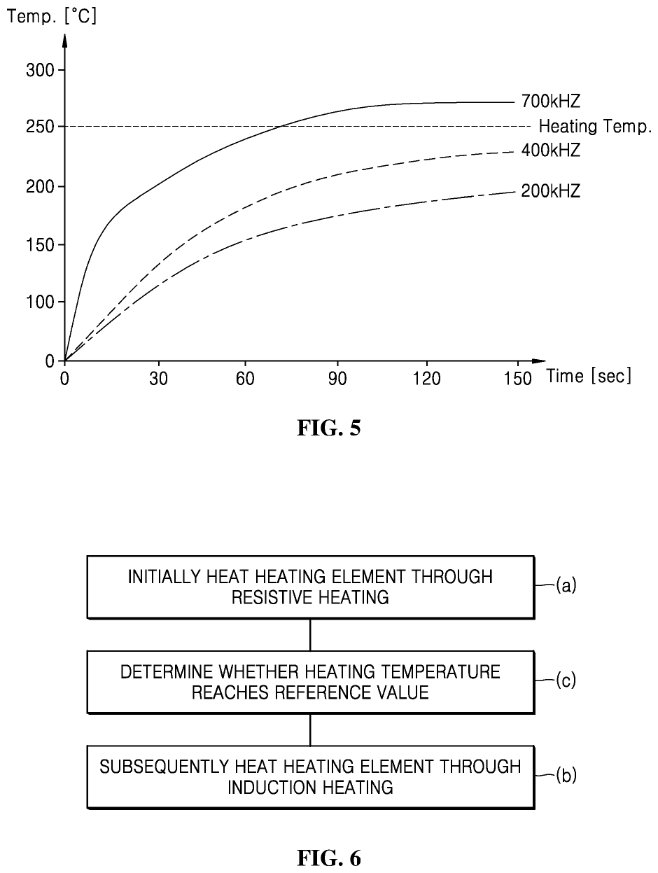

FIG. 5 is a graph showing a heating temperature over time based on a frequency of power applied by the induction heater control circuit 52 of the dual-heating tobacco heater 100 of FIG. 1.

The induction heater control circuit 52 of FIG. 4 may apply high-frequency power to the second heater H2 by using the induction heater IC 57 having a full-bridge converter and, as shown in the graph of FIG. 5, a time taken to reach the heating temperature may be reduced when the frequency of the high-frequency power is increased to 200 kHz, 400 kHz, and 700 kHz.

Therefore, according to the present invention, because the heating temperature may not be rapidly achieved using only induction heating, as described above, a heating rate may be initially increased using the first heater H1 for direct heating and then energy efficiency of a battery may be maximized by applying high-frequency power to the second heater H2 by selecting an optimal frequency such as 200 kHz, 400 kHz, or 700 kHz in consideration of battery consumption.

The time taken to reach the heating temperature based on the frequency in FIG. 5 may vary depending on a heating environment, heater specifications, a tobacco container shape, or the like, and the frequency of the high-frequency power applied to the second heater H2 may be optimally designed depending on a given condition.

Meanwhile, the present invention may also provide a heated tobacco product including the above-described dual-heating tobacco heater 100 according to some embodiments of the present invention.

The configuration and function of the heated tobacco product of the present invention may equally correspond to those of the above-described dual-heating tobacco heater 100, and thus a detailed description thereof is not provided herein.

FIG. 6 is a flowchart of a dual-heating tobacco heating method according to some embodiments of the present invention.

As illustrated in FIGS. 1 to 6, the dual-heating tobacco heating method according to some embodiments of the present invention may include (a) applying power for resistive heating to the first heater H1 being in thermal contact with the heating element 10 to directly heat the heating element 10 through resistive heating, for a certain period of time or at an early stage of heating when a heating temperature is lower than a reference value, (c) determining whether the heating temperature reaches the reference value, by measuring a resistance value of the first heater H1, and (b) applying high-frequency power for induction heating to the second heater H2 spaced apart from the heating element 10 by a certain distance to heat the heating element 10 through induction heating, after the certain period of time or after the heating temperature reaches the reference value.

Accordingly, optimal heating efficiency may be maximized and a heat maintenance period may be increased with a low battery capacity by heating the heating element 10 to a proper temperature within a short time through direct heating and then greatly reducing power consumption of the heating element 10 through induction heating, applicability to heated tobacco products using a separate holder may be achieved, and accurate and precise temperature control may be enabled by sensing a temperature based on a resistance value measured during direct heating.

As described above, according to an embodiment of the present invention, optimal heating efficiency may be maximized and a heat maintenance period may be increased with a low battery capacity by heating a heating element to a proper temperature within a short time through direct heating and then greatly reducing power consumption of the heating element through induction heating, applicability to heated tobacco products using a separate holder may be achieved, and accurate and precise temperature control may be enabled by sensing a temperature based on a resistance value measured during direct heating. However, the scope of the present invention is not limited to the above-described effects.

While the present invention has been particularly shown and described with reference to embodiments thereof, it will be understood by one of ordinary skill in the art that various changes in form and details may be made therein without departing from the scope of the present invention as defined by the following claims.

What is claimed is:

1. A dual-heating tobacco heater, comprising:
a heating element having a shape corresponding to at least a part of a tobacco container to heat the tobacco container;
a first heater being in thermal contact with the heating element to heat the heating element through resistive heating;
a second heater spaced apart from the heating element by a certain distance to heat the heating element through induction heating; and
an insulating member provided between the first and second heaters.

2. The dual-heating tobacco heater of claim 1, wherein the heating element has a pipe shape to insert therein a part of the tobacco container having a cylindrical shape, and is made of metal capable of achieving high thermal conductivity and enabling induction heating.

3. The dual-heating tobacco heater of claim 2, wherein the first heater is a direct heater wound around an outer circumferential surface of the heating element in a coil shape, and
wherein the second heater is an induction heater wound around an outer circumferential surface of the insulating member in a coil shape.

4. The dual-heating tobacco heater of claim 2, wherein the insulating member is made of at least one of polyetheretherketone (PEEK), Teflon, plastic, an air layer, and combinations thereof, which have high heat resistance.

5. The dual-heating tobacco heater of claim 2, further comprising:
an electromagnetic shield surrounding the second heater to block electromagnetic waves generated by the second heater; and
a protection member surrounding the electromagnetic shield to protect the electromagnetic shield.

6. The dual-heating tobacco heater of claim 1, further comprising a controller for applying direct current (DC) or alternating current (AC) power for resistive heating to the first heater for a certain period of time or at an early stage of heating when a heating temperature is lower than a reference value, and applying high-frequency power for induction heating to the second heater after the certain period of time or after the heating temperature reaches the reference value.

7. The dual-heating tobacco heater of claim 6, wherein the controller comprises:
a resistive heater control circuit for applying the DC or AC power for resistive heating to the first heater;
an induction heater control circuit for applying the high-frequency power for induction heating to the second heater by using a full-bridge converter;
a resistance value measurer for measuring a resistance value of the first heater and outputting a resistance value signal;
a temperature determiner for calculating temperature information of the first heater by using the resistance value measured by the resistance value measurer, and applying a switch control signal based on the calculated temperature information; and
a switch for receiving the switch control signal from the temperature determiner to drive the resistive heater control circuit for the certain period of time or at the early stage of heating when the heating temperature is lower than the reference value, or drive the induction heater control circuit after the certain period of time or after the heating temperature reaches the reference value.

8. A heated tobacco product comprising the dual-heating tobacco heater of claim 1.

9. A dual-heating tobacco heating method, comprising:
(a) applying power for resistive heating to a first heater being in thermal contact with a heating element to directly heat the heating element through resistive heating, for a certain period of time or at an early stage of heating when a heating temperature is lower than a reference value; and
(b) applying high-frequency power for induction heating to a second heater spaced apart from the heating element by a certain distance to heat the heating element through induction heating, after the certain period of time or after the heating temperature reaches the reference value.

10. The dual-heating tobacco heating method of claim 9, further comprising, before step (b), (c) determining whether the heating temperature reaches the reference value, by measuring a resistance value of the first heater.
